(19) United States
(12) Patent Application Publication
(10) Pub. No.: US 2007/0068005 A1
(43) Pub. Date: Mar. 29, 2007

(54) Hairdressing scissors

(76) Inventor: Wen-Ya Yeh, Tainan City (TW)

Correspondence Address: PRO-TECHTOR INTERNATIONAL SERVICES, 20775 NORADA CT., SARATOGA, CA, 95070, US

(21) Appl. No.: 11/234,688

(22) Filed: Sep. 23, 2005

(51) Int. Cl. B26B 13/00

(52) U.S. Cl. 30/226

(57) ABSTRACT

A pair of scissors comprises a first blade, a second blade pivotally secured to the first blade, at least a retainer installed on at least one of the first and second blades, the retainer having a base, on an outer surface of the base formed at least a locking portion. At least a locking block installed on at least one of the first and second blades, the locking block having at least a connecting hole, on an inner surface of the connecting hole formed at least a locking portion, two pairs of scissors are secured to each other in such a manner that the retainer of the first scissors is locked in connecting hole of the second scissors, and the locking portion of the base is engaged with the locking portion of the connecting hole.

### BACKGROUND OF THE INVENTION

1. Field of the Invention

The present invention relates to a pair of hairdressing scissors, and more particularly to a pair of hairdressing scissors having connecting device formed on the handle portion thereof, so that plural pairs of such hairdressing scissors can be detachably secured to one another.

2. Description of the Prior Arts

A hairstylist cuts a customer's hair with several techniques, including trimming, thinning, layering, etc. Sometimes the hairstylist has to hold plural pairs of scissors in the same hand for proceeding with the thinning or layering of the hair to obtain the desired special hairstyle.

During operation of the plural pairs of scissors in the same hand, the user must keep the plural pairs of scissors be spaced at regular intervals and operate them with the same operating condition. The plural pairs of scissors must open and close synchronously to obtain a tidy, beautiful hairstyle. However, the plural pairs of scissors are simply held by fingers of the user such that the plural pairs of scissors cannot be operated synchronously due to touchy control of the plural pairs of scissors by the fingers. Thus, the plural pairs of scissors often become skew to one another and the spacing therebetween may be different from one another. The haircutting result is adversely affected, and this problem is aggravated if the user is inexperienced. The user often feels pain when operating the plural pairs of scissors in addition to numerous limitations to and difficulties in operation.

U.S. Pat. No. 6,434,833 B1 discloses hairdressing scissor assemblies to solve the above-mentioned problems, as shown in FIG. 1, two pairs of hairdressing scissors 3 and 3a each comprises a first blade 31 and a second blade 32 each having a handle portion 311, 321 formed at an end thereof. Each of the handle portions 311 and 321 has two sides, in one of the sides is formed at least a positioning hole 312, 322 for engaging with a retainer 34, and in another one of the sides is formed at least a positioning groove 313, 323 for accommodation of a ring 35. The ring 35 can be made of flexible plastic. A pivot 33 pivotally connects the first and second blades with each other.

The two pairs of hairdressing scissors 3 and 3a are coupled together in such a manner that the retainers 34 of the pair of scissors 3a are inserted in the rings 35 of the pair of scissors 3, and the friction between the retainers 34 and the rings 35 make the two pairs of hairdressing scissors 3 and 3a connect together. In other words, the two pairs of scissors are connected together by means of the friction force of the inner surface of the rings 35 with respect to the outer surface of the retainers 34. Therefore, the fiction force is determined by the clearance fit between the pairs of scissors, if too tight, the retainers 34 can't be inserted in the rings 35 easily, and if too loose, the pairs of scissors can't be coupled together firmly.

The present invention has arisen to mitigate and/or obviate the afore-described disadvantages.

### SUMMARY OF THE INVENTION

The primary objective of the present invention is to provide a pair of hairdressing scissors having connecting device formed on the handle portion thereof, so that plural pairs of such hairdressing scissors can be detachably secured to one another.

A pair of scissors in accordance with the present invention comprises:

a first blade;

a second blade pivotally secured to the first blade;

at least a retainer installed on at least one of the first and second blades, the retainer having a base, on an outer surface of the base formed at least a locking portion; and

at least a locking block installed on at least one of the first and second blades, the locking block having at least a connecting hole, on an inner surface of the connecting hole formed at least a locking portion, two pairs of scissors are secured to each other in such a manner that a retainer of a first one of the two pairs of scissors is locked in connecting hole of a second one of the two pairs of scissors, and the locking portion of the base is engaged with the locking portion of the connecting hole.

The locking portion of the retainer and that of the locking block can be in the form of an annular groove or annular rib, or an inconsecutive annular member made up of a plurality of ribs.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a hairdressing scissor assemblies disclosed by U.S. Pat. No. 6,434,833 B1;

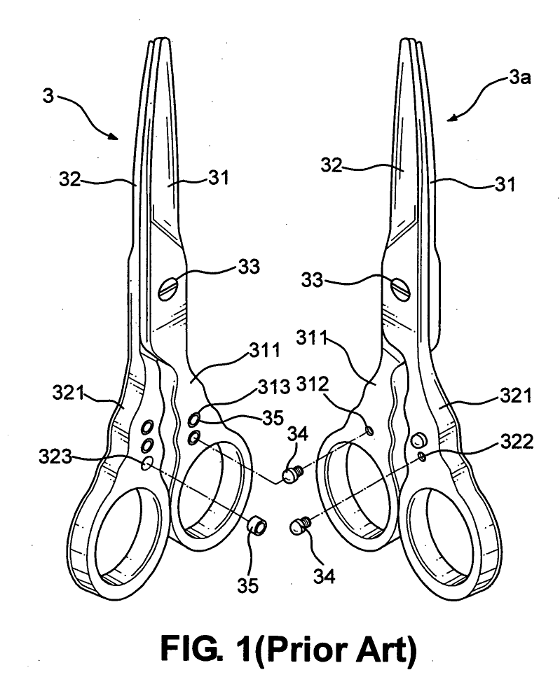

FIG. 2 is a perspective view of two pairs of hairdressing scissors in accordance with a first embodiment of the present invention;

FIG. 3 is an enlarged view of a part of the pair of scissors 1a shown in FIG. 2;

FIG. 4 is a perspective view of showing the connecting device 2 in accordance with the first embodiment;

FIG. 5 is a cross sectional view of showing the status after the two pairs of scissors 1 and 1a are coupled together;

FIG. 6 shows a connecting device in accordance with a second embodiment of the present invention;

FIG. 7 is a cross sectional view in accordance with the second embodiment, of showing the status after the two pairs of scissors 1 and 1a are coupled together;

FIG. 8 shows a connecting device in accordance with a third embodiment of the present invention;

FIG. 9 is a cross sectional view in accordance with the third embodiment, of showing the status after the two pairs of scissors 1 and 1a are coupled together;

FIG. 10 shows two pairs of scissors in accordance with a fourth embodiment of the present invention, wherein the scissors are provided with a plurality of connecting holes;

FIG. 11 shows two pairs of scissors in accordance with a fifth embodiment of the present invention, wherein the scissors are provided with a plurality of cavities; and

FIG. 12 shows two pairs of scissors in accordance with a sixth embodiment of the present invention, wherein the retainer and the locking block of the connecting device are integral with each other.

### DETAILED DESCRIPTION OF THE PREFERRED EMBODIMENTS

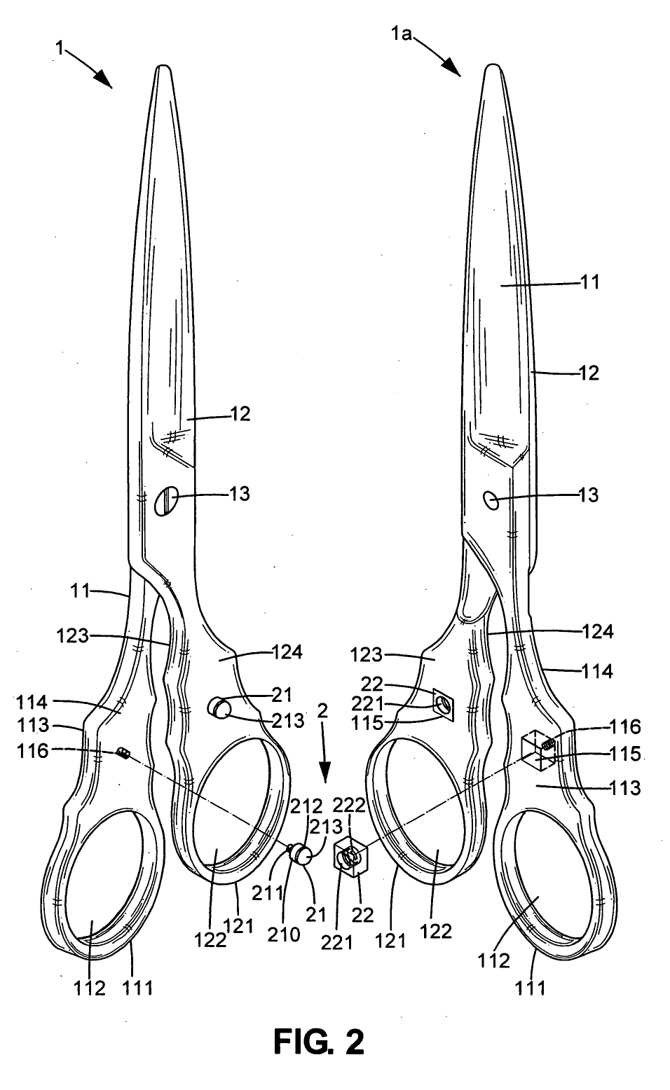

Referring to FIG. 2, which is a perspective view of a pair of hairdressing scissors in accordance with a first embodiment of the present invention, in which, two pairs of hairdressing scissors 1 and 1a are coupled together. The two pairs of hairdressing scissors 1 and 1a each comprises a first blade 11 and a second blade 12 that each has a handle portion 111, 121 at an end thereof. Each of the handle portions 111 and 121 is defined with an opening 112 and 122 for fingers of the user. A pivot 13 pivotally connects the first and second blades with each other.

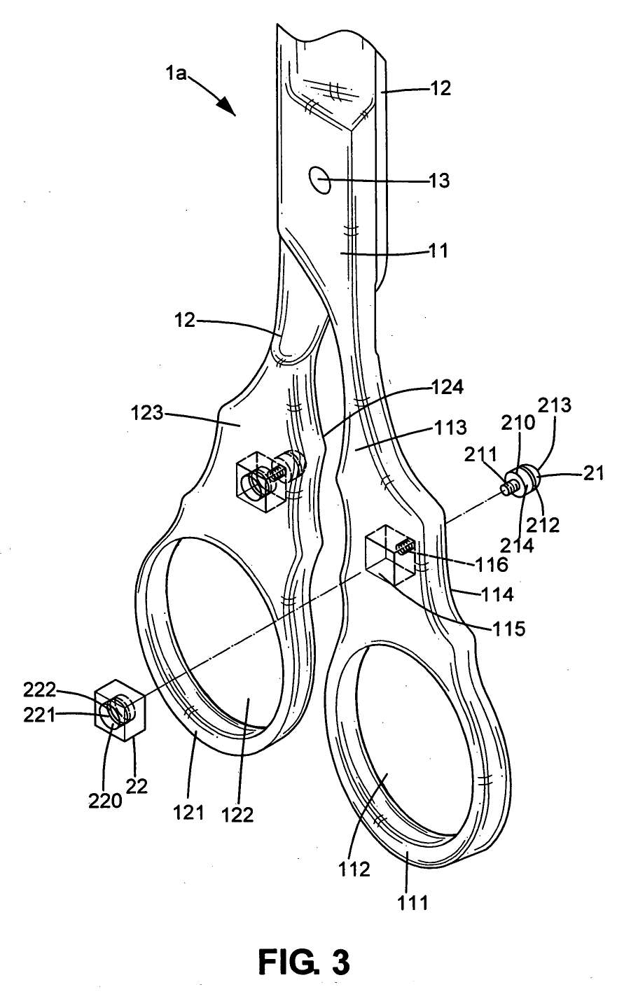

Referring to FIGS. 2 and 3, FIG. 3 is an enlarged view of a part of the pair of scissors 1a shown in FIG. 2. The handle portions 111 and 121 each include a first surface 113 and 123 and a second surface 114 and 124. At least one of the handle portions 111 and 121 of the pair of hairdressing scissors 1 is formed on a surface thereof with at least a cavity 115 and on another surface thereof opposite the cavity 115 with a threaded hole 116. A connecting device 2 comprises a retainer 21 and a locking block 22 that can be engaged with each other. The retainer 21 is screwed in the threaded hole 116, and the locking block 22 is installed in the cavity 115. In this embodiment, the cavity 115 is formed on the first surfaces 113 and 123 of the handle portions 111 and 121, and the threaded hole 116 is formed on the second surfaces 114 and 124. The cavity 115 and the threaded hole 116 are blind.

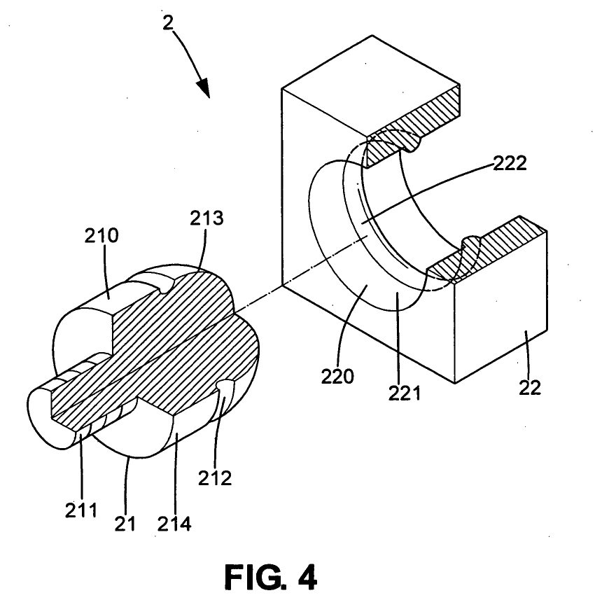

Referring to FIGS. 3 and 4, FIG. 4 is a perspective view of showing the connecting device 2 in accordance with the first embodiment. The retainer 21 includes a base 210 and a threaded portion 211 extending from an end thereof. The threaded portion 211 is to be screwed in the threaded hole 116. At another end of the retainer 21 is formed a head portion 213 whose cross section is smaller than that of the base 210. The head portion 213 can be made by forming a bevel or chamfer at the terminal periphery of the base 210, such that the head portion 213 can be inserted into the locking block 22 more easily. On the outer surface 214 of the base 210 is formed a locking portion 212 that is in the form of an annular groove.

The locking block 22 has a shape corresponding to the shape of the cavity 115 so that it can be positioned closely in the cavity 115. The locking block 22 is formed at least a connecting hole 221 for accommodation of the base 210 of the retainer 21, and on the inner surface 220 of the connecting hole 221 is formed a locking portion 222 for engaging with the locking portion 212 of the retainer 21. The locking portion 222 is an annular rib.

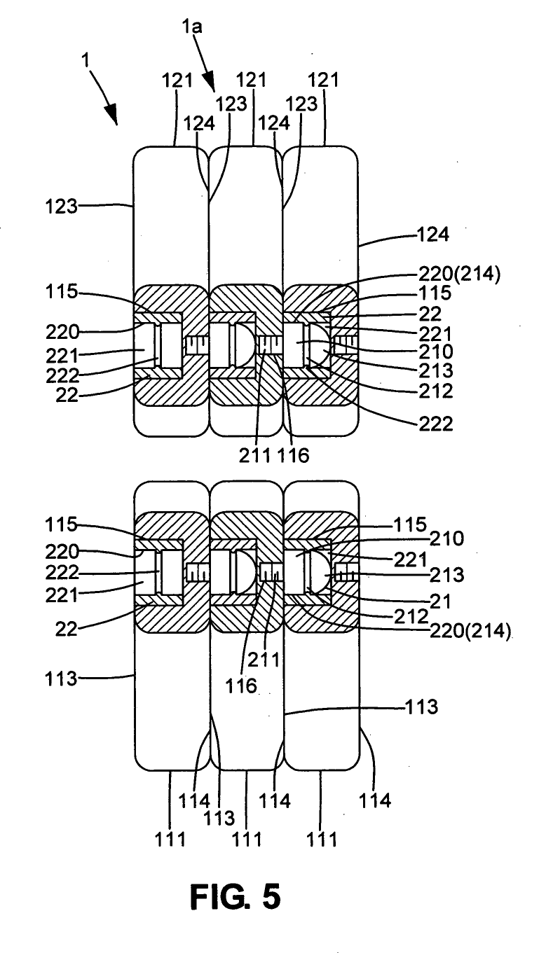

Referring to FIGS. 2 and 5, FIG. 5 is a cross sectional view of showing the status after the two pairs of scissors 1 and 1a are coupled together. The two pairs of hairdressing scissors 1 and 1a are coupled to each other by the following steps: abutting the first surfaces 113 and 123 of the pair of hairdressing scissors 1a against the second surfaces 114 and 124 of the pair of hairdressing scissors 1; inserting the retainer 21 of the scissors 1 into the connecting hole 221 of the locking block 22 of the scissors 1a, meanwhile, the locking portion 222 of the locking block 22 will be engaged with the locking portion 212 of the retainer 21. In this way, the outer surface 214 of the retainer 21 will abut against the inner surface 220 of the connecting hole 221, producing a friction force, and thus the two pairs of scissors 1 and 1a can be connected firmly by the friction force and the engagement between the two locking portions 212 and 222.

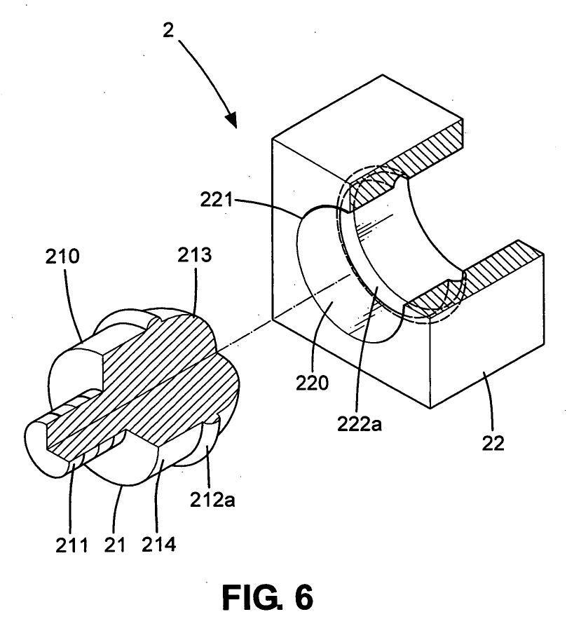

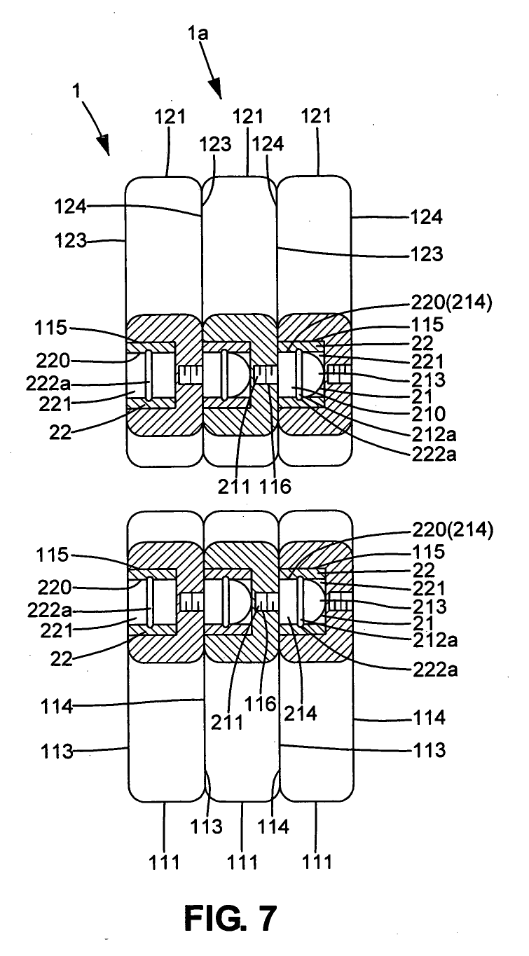

Referring to FIGS. 6 and 7, FIG. 6 shows a connecting device in accordance with a second embodiment of the present invention, FIG. 7 is a cross sectional view in accordance with the second embodiment, of showing the status after the two pairs of scissors 1 and 1a are coupled together. Components in this embodiment identical or equivalent to the first embodiment are indicated by the same reference number. The second embodiment is similar to the first embodiment, except that the locking portion 212a of the retainer 21 is an annular rib formed on the outer surface 214, and the locking portion 222a of the locking block 22 is an annular groove formed on the inner surface 220. With reference to FIG. 7, after the two pairs of scissors 1 and 1a are assembled together, the locking portion 212a of the retainer 21 will be engaged in the locking portion 222a of the locking block 22.

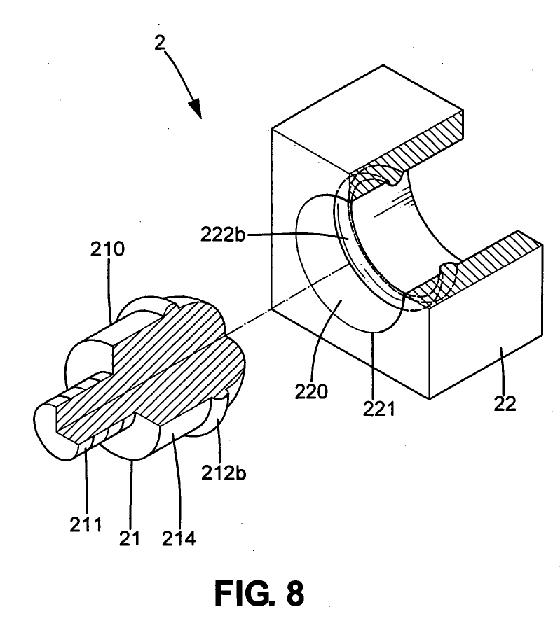

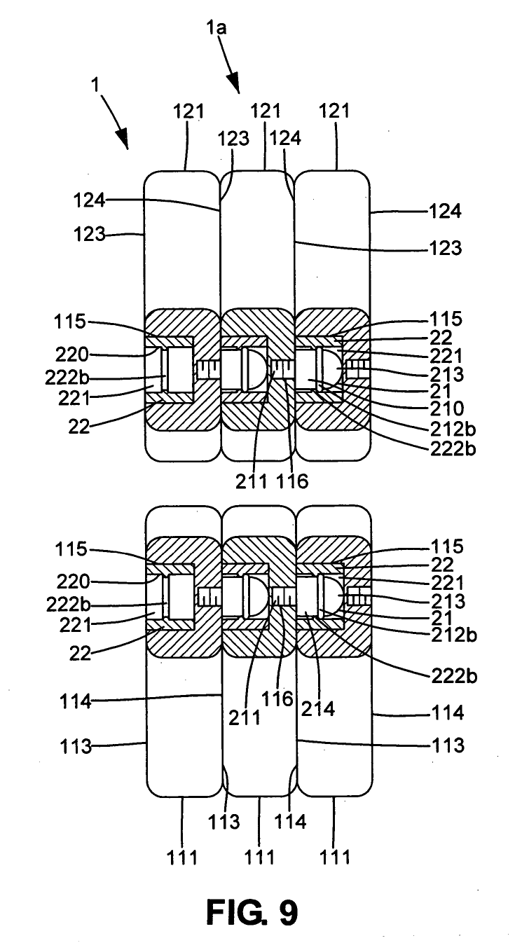

Referring to FIGS. 8 and 9, FIG. 8 shows a connecting device in accordance with a third embodiment of the present invention, FIG. 9 is a cross sectional view in accordance with the third embodiment, of showing the status after the two pairs of scissors 1 and 1a are coupled together. Components in this embodiment identical or equivalent to the first embodiment are indicated by the same reference number. The third embodiment is similar to the first embodiment, except that the locking portion 212b of the retainer 21 is an annular rib formed on the outer surface 214 thereof, and the locking portion 222b of the locking block 22 also is an annular rib formed on the inner surface 220. With reference to FIG. 9, after the two pairs of scissors 1 and 1a are assembled together, the locking portion 212b of the retainer 21 will be pushed into the space behind the locking portion 222b of the locking block 22 and will be positioned therein. In this way, the two pairs of scissors can be detachably coupled together.

The retainer 21 and the connecting hole 221 in the aforementioned three embodiments are preferably circular in cross section for easy production, however, the cross section also can be any other shapes, such as quadrangle, pentagon, hexagon. Furthermore, the locking portion in the respective embodiments-also is not limited to the complete circular rib, but also can be in other forms, such as a plurality of inconsecutive annular ribs.

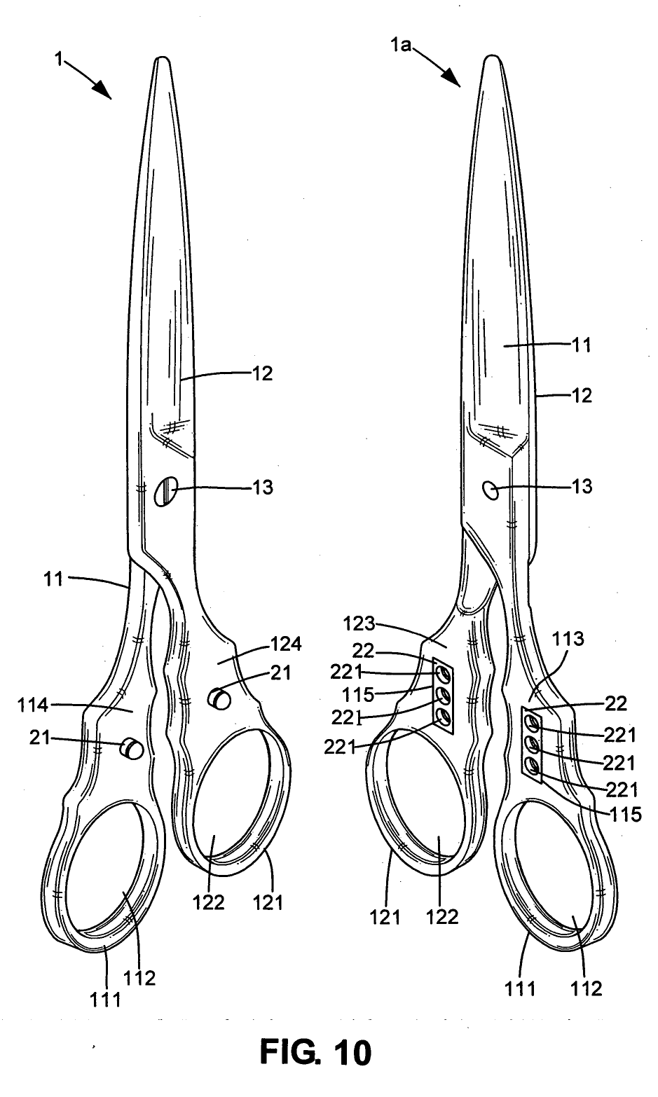

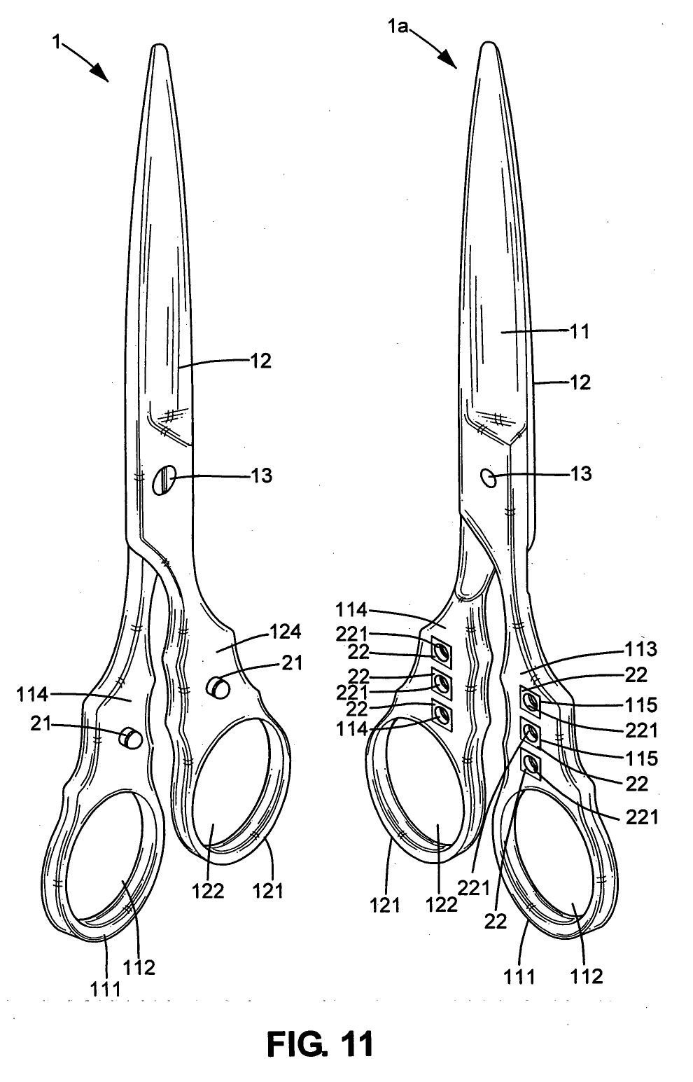

The locking block on the handle portion also can be in other forms, as shown in FIG. 10, which shows a fourth embodiment of the present invention, the locking block 22 is formed with a plurality of connecting holes 221. And as shown in FIG. 11, which shows a fifth embodiment of the present invention, in which, the handle portions 111 and 121 are formed with a plurality of cavities 115 for engaging with a plurality of locking blocks 22, such that the pairs of scissors can be coupled with each other at different positions.

It will be noted that the connecting method in the aforementioned embodiments is not limited to the threaded portion 211 of the retainer 21 screwed in the threaded hole 116. The retainer 21 also can be connected to the scissors by other means, such as soldering, riveting, and adhesion. Likewise, the locking block 22 also can be connected to the scissors by other means, such as screwing, soldering, riveting, and adhesion.

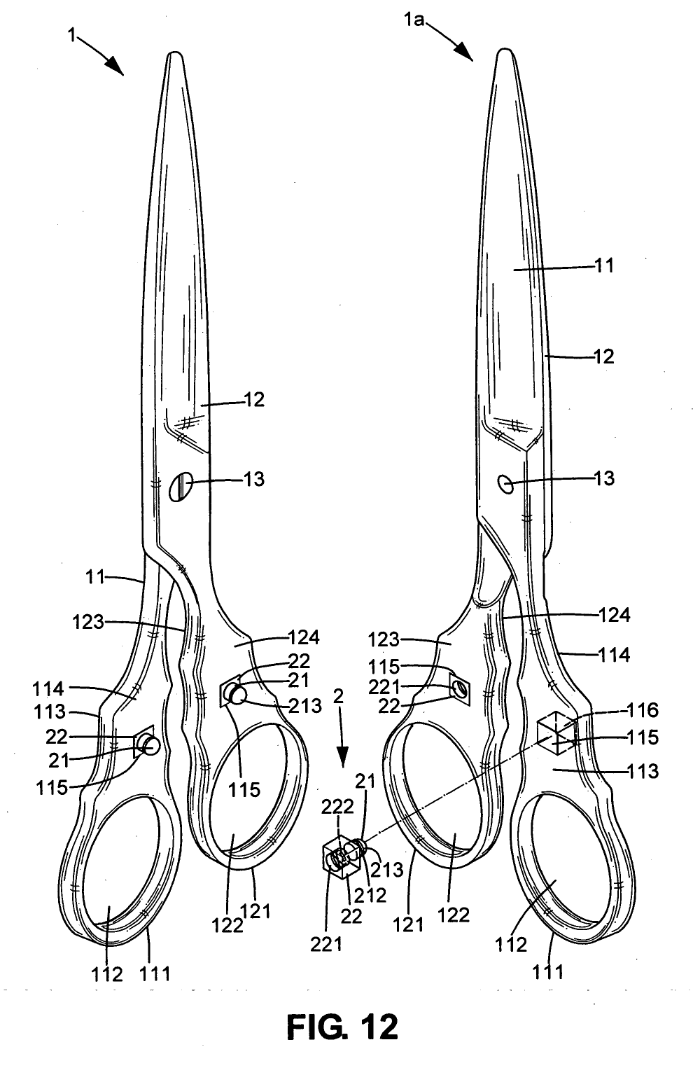

The retainer 21 and the locking block 22 of the connecting device 2 in the aforementioned embodiments are two independent components separately installed on the two sides of a scissors, however, they also can be integral with each other, as shown in FIG. 12 which shows a sixth embodiment of the present invention. In this embodiment, the cavity 115 is a through hole passing through the thickness of the scissors.

While we have shown and described various embodiments in accordance with the present invention, it should be clear to those skilled in the art that further embodiments may be made without departing from the scope of the present invention.

What is claimed is:

1. A pair of scissors comprising:
a first blade;
a second blade pivotally secured to the first blade;
at least a retainer installed on at least one of the first and second blades, the retainer having a base, on an outer surface of the base formed at least a locking portion; and
at least a locking block installed on at least one of the first and second blades, the locking block having at least a connecting hole, on an inner surface of the connecting hole formed at least a locking portion, two pairs of scissors are secured to each other in such a manner that a retainer of a first one of the two pairs of scissors is locked in connecting hole of a second one of the two pairs of scissors, and the locking portion of the base is engaged with the locking portion of the connecting hole.

2. The pair of scissors as claimed in claim 1, wherein the locking portion of the base is an annular groove formed in the outer surface of the base, and the locking portion in the connecting hole of the locking block is an annular rib formed on the inner surface of the connecting hole.

3. The pair of scissors as claimed in claim 1, wherein the locking portion of the base is an annular groove formed in the outer surface of the base, and the locking portion in the connecting hole of the locking block is in the form of a plurality of ribs formed on the inner surface of the connecting hole.

4. The pair of scissors as claimed in claim 1, wherein the locking portion of the base is an annular rib formed on the outer surface of the base, and the locking portion in the connecting hole of the locking block is an annular groove formed in the inner surface of the connecting hole.

5. The pair of scissors as claimed in claim 1, wherein the locking portion of the base is in the form of a plurality of annular ribs formed on the outer surface of the base, and the locking portion in the connecting hole of the locking block is an annular groove formed in the inner surface of the connecting hole.

6. The pair of scissors as claimed in claim 1, wherein at least one of the first blade and the second blade is formed at least a cavity for accommodation of the locking block.

7. The pair of scissors as claimed in claim 1, wherein at least one of the first blade and the second blade is formed at least a threaded hole for screwing with a threaded portion of the retainer.

8. A pair of scissors comprising:
a first blade;
a second blade pivotally secured to the first blade; and
at least a connecting device installed on at least one of the first and second blades, the connecting device including a retainer and a locking block that are integral with each other and are located on both sides of at least one of the first blade and the second blade, the retainer having a base, on an outer surface of the base formed at least a locking portion; and the locking block having at least a connecting hole, on an inner surface of the connecting hole formed at least a locking portion, two pairs of scissors are secured to each other in such a manner that a retainer of a first one of the two pairs of scissors is locked in connecting hole of a second one of the two pairs of scissors, and the locking portion of the base is engaged with the locking portion of the connecting hole.

9. The pair of scissors as claimed in claim 8, wherein at least one of the first blade and the second blade is formed at least a through cavity accommodation of the connecting device.

10. The pair of scissors as claimed in claim 8, wherein the locking portion of the base is an annular groove formed in the outer surface of the base, and the locking portion in the connecting hole of the locking block is an annular rib formed on the inner surface of the connecting hole.

11. The pair of scissors as claimed in claim 8, wherein the locking portion of the base is an annular groove formed in the outer surface of the base, and the locking portion in the connecting hole of the locking block is in the form of a plurality of ribs formed on the inner surface of the connecting hole.

12. The pair of scissors as claimed in claim 8, wherein the locking portion of the base is an annular rib formed on the outer surface of the base, and the locking portion in the connecting hole of the locking block is an annular groove formed in the inner surface of the connecting hole.

13. The pair of scissors as claimed in claim 8, wherein the locking portion of the base is in the form of a plurality of annular ribs formed on the outer surface of the base, and the locking portion in the connecting hole of the locking block is an annular groove formed in the inner surface of the connecting hole.

14. A pair of scissors comprising:
a first blade;
a second blade pivotally secured to the first blade;
at least a retainer installed on at least one of the first and second blades, the retainer having a base, on an outer surface of the base formed at least a locking portion; and
at least a locking block installed on at least one of the first and second blades, the locking block having at least a connecting hole, on an inner surface of the connecting hole formed at least a locking portion, two pairs of scissors are secured to each other in such a manner that a retainer of a first one of the two pairs of scissors is locked in connecting hole of a second one of the two pairs of scissors, and the locking portion of the base is pushed into a space behind the locking portion of the locking block and is positioned therein.

15. The pair of scissors as claimed in claim 14, wherein the locking portion of the base is an annular rib formed on the outer surface of the base, and the locking portion in the connecting hole of the locking block is an annular rib formed on the inner surface of the connecting hole.

16. The pair of scissors as claimed in claim 14, wherein the locking portion of the base is an annular rib formed on the outer surface of the base, and the locking portion in the connecting hole of the locking block is in the form of a plurality of ribs formed on the inner surface of the connecting hole.

17. The pair of scissors as claimed in claim 14, wherein the locking portion of the base is in the form of a plurality of ribs formed on the outer surface of the base, and the locking portion in the connecting hole of the locking block is an annular rib formed on the inner surface of the connecting hole.

18. The pair of scissors as claimed in claim 14, wherein at least one of the first blade and the second blade is formed with at least a cavity and a threaded hole, the cavity is provided for receiving the locking block, and the threaded hole is for screwing with a threaded portion of the retainer.

19. The pair of scissors as claimed in claim 14, wherein the locking block is integral with the retainer, forming a connecting device, and at least one of the first blade and the second blade is formed at least a through cavity accommodation of the connecting device.
